(19) United States
(12) Patent Application Publication
(10) Pub. No.: US 2004/0043683 A1
(43) Pub. Date: Mar. 4, 2004

(54) Method of manufacturing a trim part under low pressure operating conditions

(75) Inventor: Michael W. Muench, Brighton, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Intier Automotive Inc.

(21) Appl. No.: 10/235,010

(22) Filed: Sep. 4, 2002

(51) Int. Cl. B32B 27/12; B32B 27/04; B32B 5/12; B32B 5/02; B32B 5/24; B32B 5/18

(52) U.S. Cl. 442/43; 442/30; 442/58

(57) ABSTRACT

A method of manufacturing a trim part, such as an airbag cover, under low pressure conditions is disclosed. The trim part includes a skin material, a scrim material, and a substrate. A mold tool comprises a first half and a second mold half. The method comprises the steps of injecting molten substrate material into one of the mold halves and partially closing the mold halves to a predetermined distance such that the molten substrate material is properly spread within the cavity of the mold tool under low pressure conditions. The molten substrate material encapsulates the scrim material and integrally bonds the scrim material to the skin material. In one method of the invention, a frame member is placed on one of the mold halves to form a groove that pre-weakens the trim part to form an airbag door for an airbag cover in one cycling operation.

### TECHNICAL FIELD

The present invention relates to interior trim parts of a vehicle, and in particular to a method of manufacturing a trim part, such as an airbag cover, under low pressure operating conditions.

### BRIEF DESCRIPTION OF THE DRAWINGS

The present invention will now be described, by way of example, with reference to the accompanying drawings, in which:

FIG. 1 is a perspective view of an airbag cover according to one embodiment of the invention;

FIG. 2 is a cross-sectional view of the airbag cover of FIG. 1;

FIG. 3 is a side elevational view of an injection mold tool for forming the airbag cover of FIG. 1;

FIG. 4 is a partial rear perspective view of the airbag cover of FIG. 1 with the scrim material not shown for clarity;

FIG. 5 is a partial rear perspective view of the airbag cover of FIG. 1 with the scrim material;

FIG. 6A is a perspective view a melt compression molding (MCM) tool in an open position;

FIG. 6B is another perspective view the MCM tool in an open position;

FIG. 6C is a perspective view the MCM tool in an closed position;

FIG. 7 is a partial rear perspective view of an airbag cover formed by the MCM tool that is pre-weakened by laser scoring the trim part; and

FIG. 8 is another partial rear perspective view of an airbag cover formed by the MCM tool that is pre-weakened by a groove that is formed by a frame that is inserted into the MCM tool.

### DESCRIPTION OF THE PREFERRED EMBODIMENTS

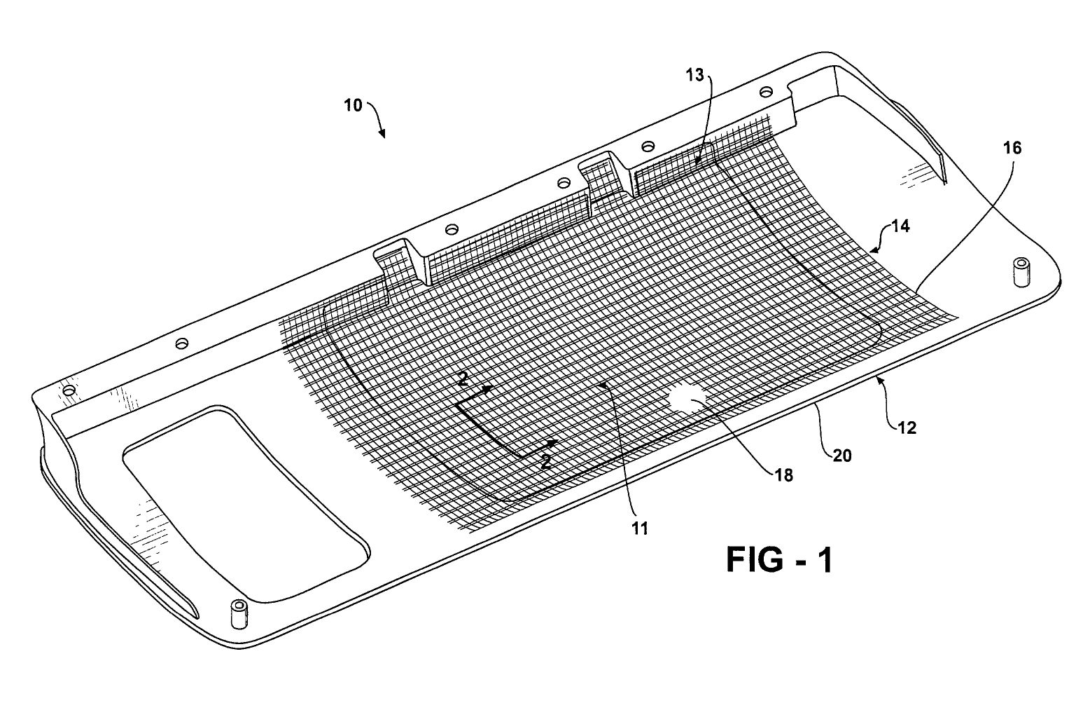

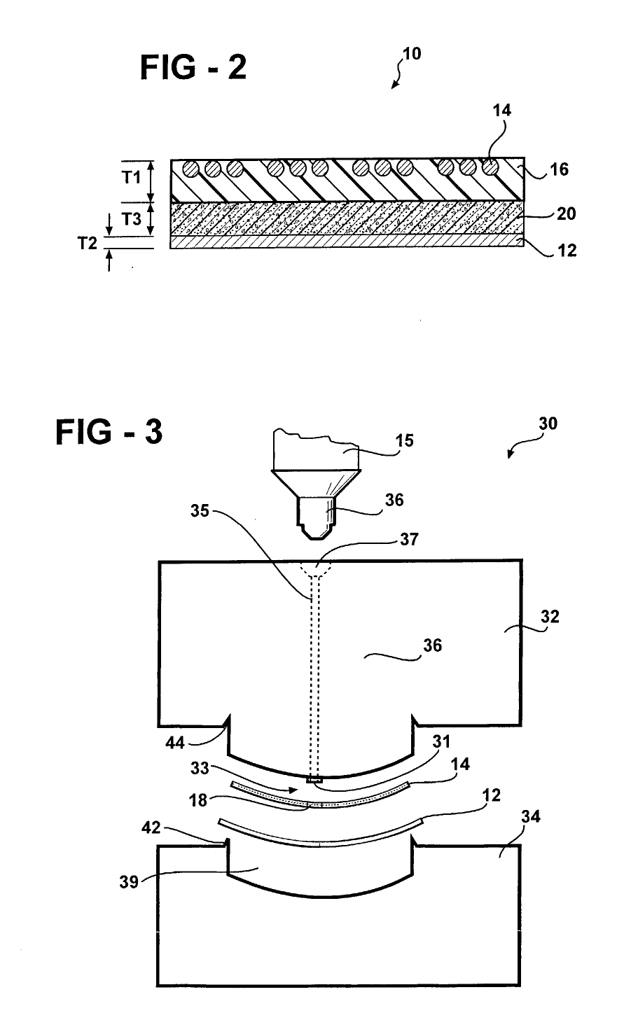

Referring to FIGS. 1 and 2, a vehicular trim part comprises a skin material 12 on the front “A” surface and a scrim material 14 on the rear “B” surface. If the trim part 10 is designed to be an air bag cover, the scrim material 14 encompasses a hinge portion 13 of the trim part 10. As described in more detail below, the skin material 12 and scrim material 14 of the trim part 10 are integrally molded and bonded together in a single operation by introducing a molten substrate material 15 (FIG. 3), which becomes cured substrate 16 after an appropriate cooling time, under low-pressure operating conditions. The trim part 10 may further comprise a foam layer 20 laminated to the skin material 12. In one embodiment of the invention, the scrim material 14 includes a gate passage 18. The purpose of the gate passage 18 is described in more detail below.

The substrate 16 may be any desirable thermoplastic resin, such as, for example, Polypropylene (PP), Acrylnitril-Butadien-Styrol-Copolymere (ABS), Polycarbonate-Acrylnitril-Butadien-Styrol-Copolymere (PC/ABS), or Thermoplastic Olefin (TPO). Referring specifically to FIG. 2, the substrate 16 has a thickness, T1, approximately equal to 2.5 mm to 3.0 mm. The skin material 12 may be TPO or polyvinyl chloride (PVC) having a thickness, T2, approximately equal to 0.5 mm. It is preferable to use TPO as a main component of the substrate 16 and skin material 12 because the entire trim part 10 would be totally recyclable. If desired, the trim part 10 may also further comprise the foam layer 20 laminated to the skin material 12, having a thickness, T3, approximately equal to 2.5 mm.

As seen in FIG. 3, the trim part 10 is molded under low-pressure operating conditions by using an injection mold tool 30. The mold tool 30 is defined by an upper mold half 32 and a lower mold half 34. A heated, low-vestige, nozzle tip 31 of a gate 33, which is located on the upper mold half 32, injects molten substrate material 15. The upper mold half 32 is further includes a heated runner 35 and a sprue 37, which cooperates with an injector head 36 to introduce the molten substrate material 15 into the mold tool 30. The lower mold half 34 defines a cavity 39 having a desired contour that forms the shape of the trim part 10.

Prior to partial closing the mold tool 30 (i.e. the injecting of molten substrate material 15 and the closing of the mold tool 30), the gate passage 18 of the scrim material 14 is placed around the nozzle tip 31 of the gate 33. The geometry of the gate passage 18 may be optimized so that it may be secured and held in place during the partial closing of the mold tool 30 in order to prevent the scrim material 14 from migrating during the molding process. The geometry of the gate passage 18 may be any desirable configuration, such as a circular cross sectional shape, that can properly accommodate the corresponding configuration of the nozzle tip 31. The securement of the gate passage 18 around the nozzle tip 31 may be supplemented by applying an adhesive material (not shown) to the scrim material 14. However, the use of adhesive material should be avoided because the adhesive may leave surface blemishes that may be visible on the “A” surface of the trim part 10.

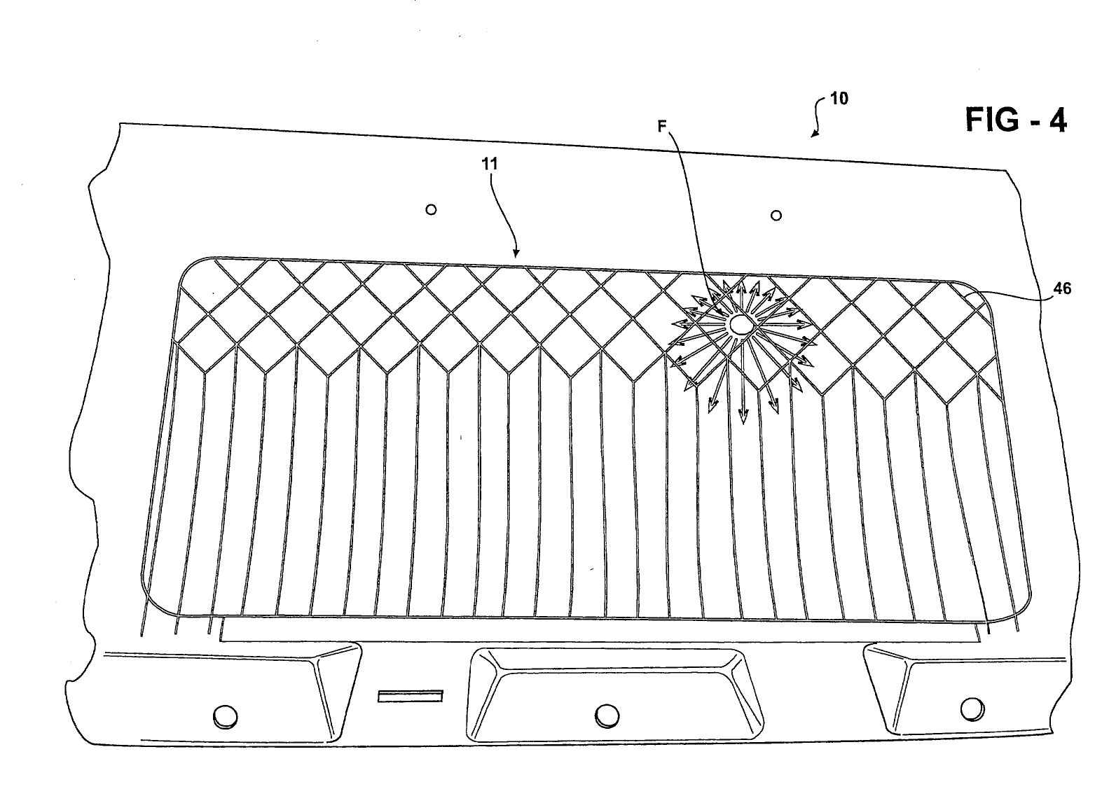

In the illustrated embodiment, the nozzle tip 31 has a diameter of approximately 25 mm. The gate passage 18 of the scrim material 14 has a slightly smaller diameter than the nozzle tip 31 so that flow direction, F, (FIG. 4) of the molten substrate material 15 securely holds the scrim material 14 against the upper mold half 32 during the molding process. Essentially, the gate passage 18 of the scrim material 14 permits the molten substrate material 15 to flow directly over the skin material 12 without any interference of the flow direction, F, of the molten substrate material 15 by the scrim material 14. Upon partial closing of the mold tool 30, the lower mold half 34 pushes the molten substrate material 15 through mesh-pattern openings of the scrim material 14, thereby encapsulating the scrim material 14 within the molten substrate material 15.

The skin material 12, which generally comprises the “A” surface, may be mechanically held in place on the mold tool 30, such as with a plurality of pins 42 on the lower mold half 34, or non-mechanically by an adhesive (not shown), such as tape. If the pins 42 are used for securing the skin material 12 to the lower mold half 34, the upper mold half 32 will include a corresponding number of pin-receiving locations 44 for receiving the pins 42 upon placing of the mold tool 30 in a closed position.

During the manufacture of the trim part 10, excess skin material 12 in the form of sheet stock material may run off the outer periphery of the lower mold half 34 or onto the outer periphery of the cavity 39. This excess material may be trimmed off with cutting surfaces (not shown) in the mold tool 30 at the parting lines (i.e. periphery of the trim part 10). Alternatively, the skin material 12 may be a preformed to a predetermined size that depends on the configuration of the trim part 10 to be molded.

When the scrim material 14 and the skin material 12 are properly positioned and secured to the mold tool 30, the molding process is initiated by partially closing the upper mold half 32 on the lower mold half 34 under low-pressure tonnage conditions. As used herein, low pressure operating conditions is defined as the upper mold half 32 and the lower mold half 34 being moved to a partially closed position to exert a pressure of approximately 1.5 to 2.0 tons per square inch. Specifically, the upper mold half 32 and the lower mold half 34 are partially closed to a predetermined distance apart, for example, about 4 mm to about 8 mm, so that the molten substrate material 15 is properly spread to conform to the cavity 39. The predetermined distance depends on the configuration of the trim part 10 and the location of the gate 33 so that the molten substrate material 15 may be properly spread before the mold tool 30 is completely positioned to its predetermined distance. It will be appreciated that the invention is not limited by the pressure exerted by upper and lower mold halves 32, 34, and that the invention can be practiced with any desirable pressure in which the molten substrate material 15 can be properly spread to conform to the cavity 39 when the mold halves 32, 34 are partially closed. In addition, the invention is not limited by the properties of the molten substrate material 15, and that the invention can be practiced with a molten substrate material 15 with any suitable properties that will allow the molten substrate material 15 to be properly spread within the cavity 39 and encapsulate the scrim material 14. The molten substrate material 15 may be injected prior to, during, or after the partial closing of the mold tool 30. Preferably, the molten substrate material 15 is injected prior to or during the partial closing of the mold tool 30.

After partially closing of the mold tool 30, the molten substrate material 15 completely bonds with both the skin material 12 and the scrim material 14 under the low pressure operating conditions in one cycling operation. As used herein, one cycling operating is defined as the partial closing of the mold tool 30 from an open position, followed by the opening of the mold tool 30 from the partially closed position. At the end of the cycling operation, the cycling of the mold tool 30 may be paused for a predetermined period of time so that the molten substrate material 15 may cool. The predetermined period of time for cooling the molten substrate material 15 may be, for example, approximately 30 to 40 seconds. Once the molten substrate material 15 is cooled, the molten substrate material 15 hardens to form the substrate 16 and the mold tool 30 can be opened to allow the trim part 10 to be ejected.

Once the molding process is completed and the trim part 10 is removed from the mold tool 30, the trim part 10 may be subsequently scored by a laser in order to provide “invisible” score lines 48. Essentially, the score lines 48 results in an airbag door 11 that renders the trim part 10 a seamless airbag cover. Any desirable, well known laser scoring machine may be used. For example, one laser scoring machine that can be used is sold under the tradename JENOPTIK® commercially available from Jenoptik Aktiengesellschaft Corporation of the Federal Republic of Germany.

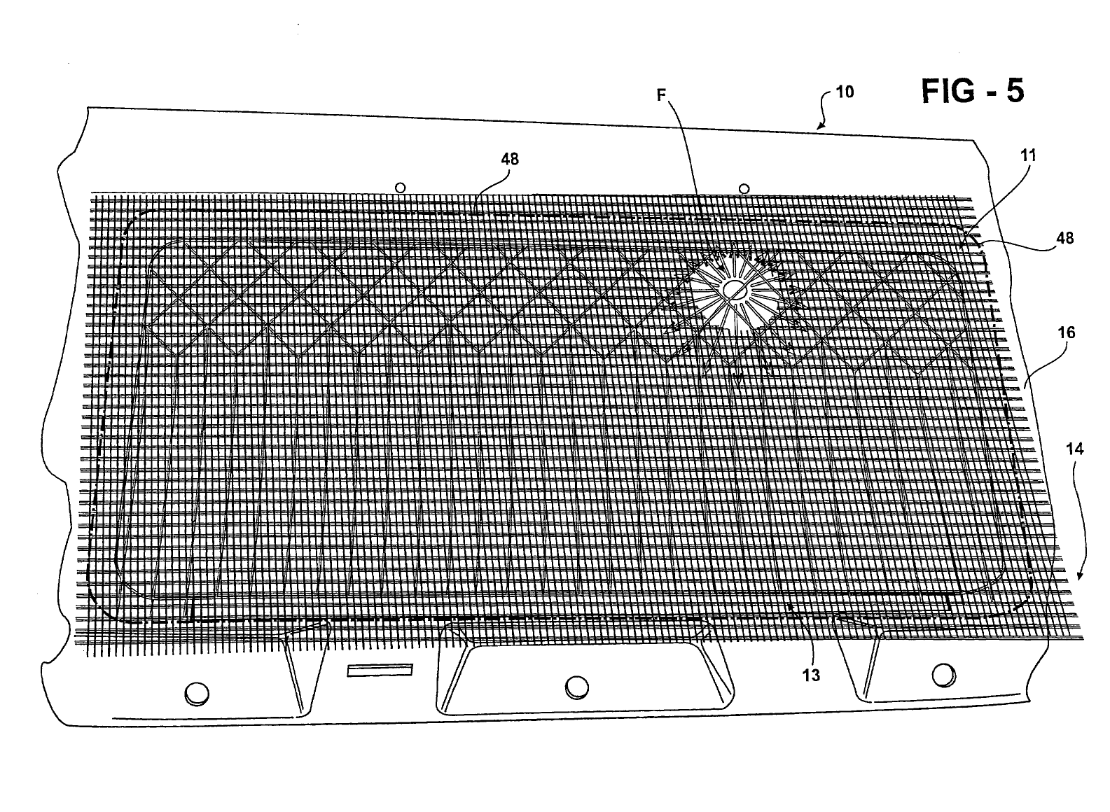

As seen in FIG. 5, when the trim part 10 is ejected, the scrim material 14 is encapsulated within the substrate 16 adjacent to the “B” surface of the trim part 10. Although the scrim material 14 is encapsulated in the substrate 16, the scrim material 14 may be still visible (i.e. the scrim material 14 leaves a ripple effect on the “B” surface). Even further, the surface of the upper mold half 32 may have a plurality of grooves (not shown) in a predetermined pattern that forms ribs 46 (FIG. 4). Essentially, the molten substrate material 15 seeps through the scrim material 14 and forms the ribs 46. If the trim part 10 is to be used as an airbag cover 10, the ribs 46 may assist in holding the scrim material 14 during deployment of the airbag door 11.

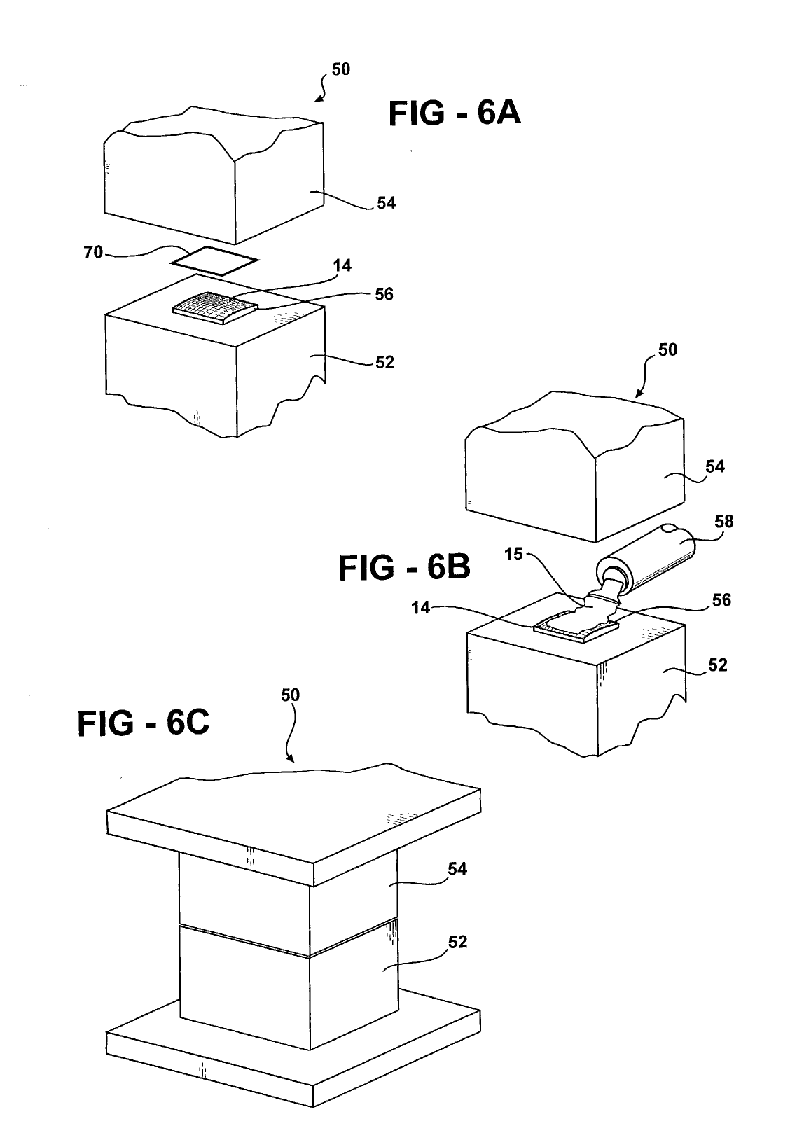

According to another embodiment of the present invention as seen in FIGS. 6A-6C, a melt compression molding (MCM) mold tool 50 may mold the trim part 10 under low pressure conditions in one operation. The trim part 10 comprises the same components described above. However, the molten substrate material 15 used in the MCM mold tool 50 may be limited to Polypropylene (PP) or Thermoplastic Olefin (TPO) because the viscosity of the molten substrate material 15 for Acrylnitril-Butadien-Styrol-Copolymere (ABS) or Polycarbonate-Acrylnitril-Butadien-Styrol-Copolymere (PC/ABS) may be too high. Essentially, the MCM process also permits the scrim material 14 and the skin material 12 to be integrally bonded by the molten substrate material 15 in a single step, thereby providing a simpler and more cost-effective method as compared to conventional molding processes.

The MCM method substantially incorporates most of the similar steps described above in the first embodiment. However, the gate passage 18 formed in the scrim material 14 is not needed and can be eliminated because the gate 33, the runner 35, injector head 36, and the sprue 37 are not included in the design of a upper mold half 54 of the MCM mold tool 50. Even further, the scrim material 14 may not have to be attached to the MCM mold tool 50 because the scrim material 14 may be placed on a boss portion 56 of a lower mold half 52. However, an adhesive material (not shown) may be used to hold the scrim material 14 in place against the lower mold half 52. The skin material 12 may be mechanically held in place in a recess (not shown) formed in the upper mold half 54 by using a plurality of pins, or non-mechanically by an adhesive (not shown), such as tape, similar to the first method of the invention.

The MCM process includes the steps of placing the scrim material 14 on the lower mold half 52 of the MCM mold tool 50 (FIG. 6A). Next, the skin material 12 is located and secured to the upper mold half 54 of the MCM mold tool 50. Next, the molten substrate material 15 is extruded with an extruder head 58 by laying a ribbon of molten substrate material 15 into the MCM mold tool 50 over the scrim material 14 (FIG. 6B). Then, the MCM mold tool 50 is partially closed under low pressure operating conditions so that that the molten substrate material 15 seeps through the grid-pattern of the scrim material 14 (FIG. 6C). Once the trim part 10 is molded, the MCM mold tool 50 is opened and ejector pins (not shown) are activated and pushes the trim part 10 out of the MCM mold tool 50.

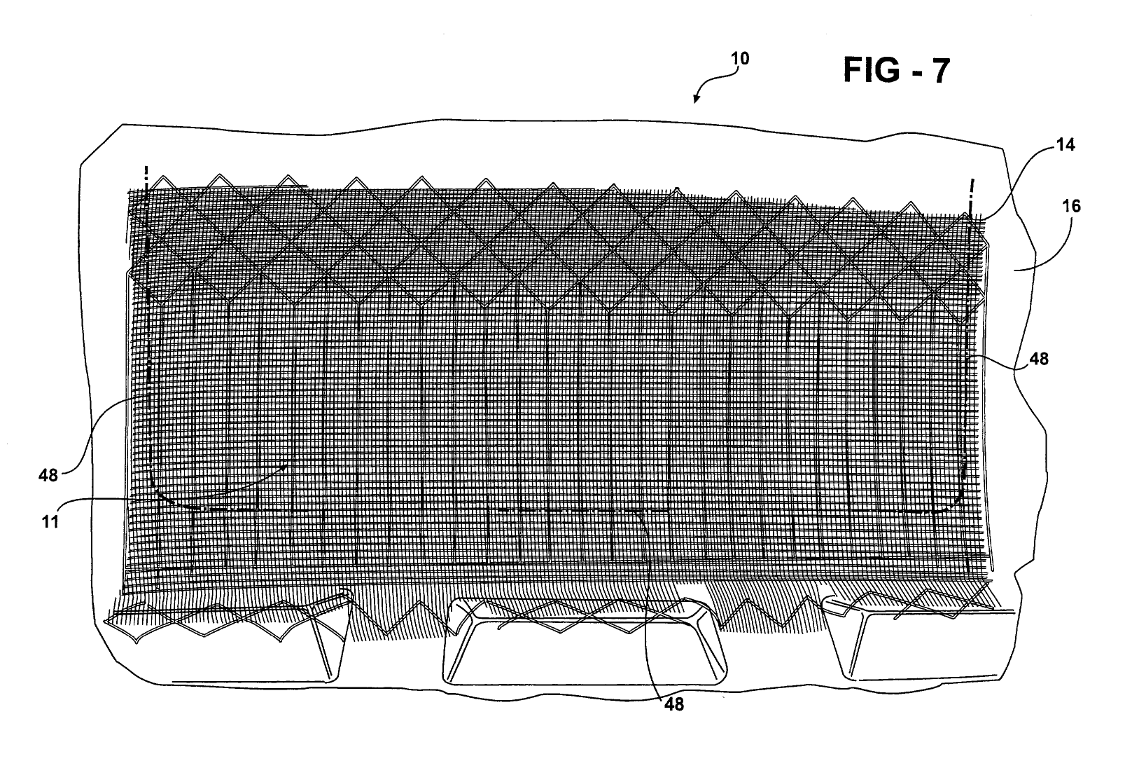

Once the trim part 10 is removed from the MCM mold tool 50, the trim part 10 may be pre-weakened by scoring the trim part 10 with any well-known laser scoring technique to provide “invisible” score lines 48 (FIG. 7) defining an airbag door 11. Once the airbag door 11 is formed by laser scoring, the trim part 10 is rendering as a seamless airbag cover 10.

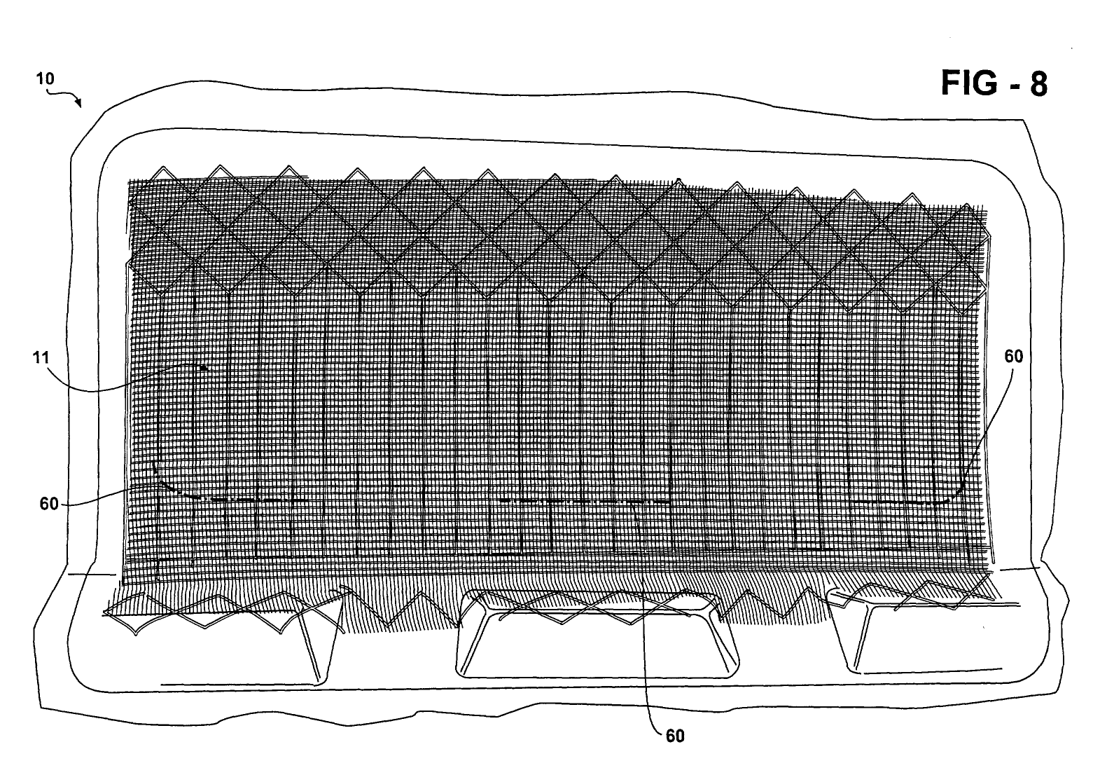

In an alternative method of the invention, a removable frame 70 including a plurality of pins (not shown), may be placed in the MCM mold tool 50 (FIG. 6A). The removable frame 70 may be desirably placed about the scrim material 14 and may be used to hold the scrim material 14 in place. Upon closing the MCM mold tool 50, the frame forms a groove 60 having a reduced thickness on the “B” surface of the trim part 10 (FIG. 8). Essentially, the groove 60 reduces the thickness by approximately 75% and leaves approximately 25% of the remaining thickness of the trim part 10. Thus, the removable frame 70 forms a weakened periphery for an airbag door 11 and the trim part 10 is rendered as a seamless airbag cover 10. The use of the frame 70 obviates the need for pre-weakening the trim part 10, such as by laser scoring, in a separate, subsequent step. The score lines 48 (FIG. 7) and groove 60 (FIG. 8) may be discontinuous (as shown), continuous, or define any desireable pattern in order to enhance the functionality of the airbag door 11.

Because the trim part 10 is molded under low pressure conditions in both illustrated methods described above, typical thermoforming and trim operations (i.e. multi- and secondary-operations) commonly associated with trim part manufacturing are eliminated. In other words, a completely manufactured trim part 10 is formed in one operation without the need for multiple cycles (opening and closing the mold halves of the mold tool), unlike conventional molding techniques that require more than one step. According to one method of the present invention, the scrim material 14 is placed against the upper mold half 32 of the mold tool 30 about the gate 33 by a gate passage 18 (FIG. 3). According to another method of the invention, the scrim material 14 may be placed over the lower mold half 52 of the MCM mold tool 50 (FIGS. 6A-6C). When the molten substrate material 15 is properly spread by partial closing of the mold halves 32, 34, the flowing action of the molten substrate material 15 for both illustrated embodiments pushes the scrim material 14 against the appropriate mold half 32, 52 of the respective mold tools 30, 50. As a result, the molten substrate material 15 encapsulates and integrally bonds the scrim material 14 to the skin material 12 in one operation.

Trimming of any excess skin material 12 is performed when the respective mold tools 30, 50 are partially closed under low pressure conditions. Although not discussed above, a vacuum may be used on the appropriate mold halves 34, 54 of the respective mold tools 30, 50 in order to secure the skin material 12 to the respective mold tools 30, 50. However, the use of a vacuum may undesirably leave an uneven “A” surface on the trim part 10 that would be visible after the vacuum is released.

The present invention also provides a method for complete manufacturing of an airbag cover 10 in a single operation. The removable frame 70 that may be used in the MCM process (FIGS. 6A-6C) forms a peripheral groove 60 and results in the pre-weakening of the airbag cover 10 for providing the airbag door 11. If laser pre-weakening is desired rather than using the removable frame 70 to pre-weaken the trim part 10, the laser pre-weakening may be carried out in a subsequent step.

Although the invention as described above is shown for molding a trim part under low pressure conditions, the invention may also apply to any vehicular trim part, such as an airbag cover, formed in a molding process having at least a scrim material, a skin material, and a substrate. It should be understood that the aforementioned and other various alternatives to the embodiments of the invention described herein may be employed in practicing the invention. It is intended that the following claims define the scope of the invention and that the method and apparatus within the scope of these claims and their equivalents be covered thereby.

What is claimed is:

1. A trim part, comprising:
a skin material;
a scrim material including a gate passage; and
a molten substrate material that encapsulates the scrim material and integrally bonds the scrim material to the skin material, wherein the molten substrate material is introduced into a mold tool under low-pressure operating conditions.

2. The trim part according to claim 1, further comprising a layer of foam laminated to the skin material.

3. The trim part according to claim 1, further comprising a pre-weakened portion.

4. The trim part according to claim 3, wherein the pre-weakened portion is a laser score line.

5. The trim part according to claim 1, wherein the skin material and the molten substrate material comprise Thermoplastic Olefin.

6. The trim part according to claim 1, wherein the molten substrate material comprises Polypropylene.

7. The trim part according to claim 1, wherein the molten substrate material comprises Acrylnitril-Butadien-Styrol-Copolymere.

8. The trim part according to claim 1, wherein the molten substrate material comprises Polycarbonate-Acrylnitril-Butadien-Styrol-Copolymere.

9. The trim part according to claim 1, wherein the skin material comprises polyvinyl chloride.

10. A method for manufacturing a trim part by a molding tool, the molding tool defined by a first mold half and a second mold half, comprising:
placing scrim material on the first mold half;
placing skin material on the second mold half; and
providing molten substrate between the scrim material and the skin material; and
partially closing the molding tool under low-pressure tonnage.

11. The method for manufacturing a trim part according to claim 10, wherein the molten substrate is provided by an injector head, a sprue, a runner, and a gate of the first mold half.

12. The method for manufacturing a trim part according to claim 11, wherein the scrim material is further defined by a gate passage, wherein the placing step is further defined by placing the gate passage of the scrim material around the gate of the first mold half.

13. The method for manufacturing a trim part according to claim 10, wherein the placing step is further defined by securing the skin material over a plurality of pins.

14. The method for manufacturing a trim part according to claim 10 further comprising the step of pre-weakening the trim part to form an airbag door for a seamless airbag cover.

15. The method for manufacturing a trim part according to claim 14, wherein the pre-weakening step is performed with a laser.

16. The method for manufacturing a trim part according to claim 14, wherein the pre-weakening step is performed by inserting a frame into the molding tool to form a groove in the trim part.

17. The method for manufacturing a trim part according to claim 10, wherein the molding tool is partially closed under low-pressure tonnage such that the first and second mold halves are separated by a predetermined distance of approximately 4 mm to 8 mm.

18. The method for manufacturing a trim part according to claim 10 further comprising the step of cooling the molten substrate material.

19. A method for manufacturing an airbag cover by a molding tool, the molding tool defined by a first mold half and a second mold half, comprising:
placing a scrim material on the first mold half, wherein the scrim material is further defined by a gate passage, wherein the placing the scrim material on the first mold half is further defined by placing the scrim material about a gate of the first mold half by the gate passage;
placing a skin material on the second mold half;
providing a molten substrate between the scrim material and the skin material;
partially closing the molding tool under low-pressure tonnage; and
pre-weakening the trim part to with a laser, wherein the laser forms a laser score line that provides a seamless airbag cover, wherein the laser score line defines an airbag door.

20. A method for manufacturing an airbag cover by a melt compression molding (MCM) mold tool, the MCM mold tool defined by a first mold half and a second mold half, comprising:
placing a scrim material on the first mold half;
placing a frame member over the scrim material;
placing a skin material on the second mold half; and
providing a molten substrate material between the scrim material and the skin material; and
partially closing the MCM mold tool under low-pressure tonnage, wherein the frame member provides a groove defining an airbag door.

21. A low-pressure molded airbag cover, comprising:
a skin material forming an “A” surface of the airbag cover;
a substrate; and
a scrim material encapsulated by the substrate and bonded to the skin material, wherein the scrim material is encapsulated by the substrate and integrally bonds the scrim material to the skin material using the method as recited in claim 10.

22. The airbag cover according to claim 21, further comprising a layer of foam laminated to the skin material.

23. The airbag cover according to claim 21, further comprising a laser score line.

24. The airbag cover according to claim 21, wherein the skin material and the substrate comprise Thermoplastic Olefin.

25. The airbag cover according to claim 21, wherein the substrate comprises Polypropylene.

26. The airbag cover according to claim 21, wherein the substrate comprises Acrylnitril-Butadien-Styrol-Copolymere.

27. The airbag cover according to claim 21, wherein the substrate comprises Polycarbonate-Acrylnitril-Butadien-Styrol-Copolymere.

28. The airbag cover according to claim 21, wherein the skin material comprises polyvinyl chloride.
